(19) United States
(12) Patent Application Publication
(10) Pub. No.: US 2026/0219678 A1
(43) Pub. Date: Jul. 30, 2026

(54) PATH PLANNING METHOD, CONTROLLER AND AUTONOMOUS MOBILE MACHINE

(71) Applicant: VisionNav Robotics USA Inc., Acworth, GA (US)

(72) Inventors: Kuisong ZHENG, Acworth, GA (US); Jianbin WANG, Acworth, GA (US); Yulin ZHANG, Acworth, GA (US)

(73) Assignee: VisionNav Robotics USA Inc., Acworth, GA (US)

(21) Appl. No.: 19/175,375

(22) Filed: Apr. 10, 2025

(30) Foreign Application Priority Data
Jan. 27, 2025 (CN) 202510126358.7

(51) Int. Cl. G05D 1/644; G05D 1/246; G05D 1/622; G05D 105/20; G05D 105/80; G05D 107/50; G05D 109/10

(52) U.S. Cl. CPC G05D 1/644; G05D 1/246; G05D 1/622; G05D 2105/20; G05D 2105/87; G05D 2107/50; G05D 2109/10

(57) ABSTRACT

A path planning method includes: determining a task start point and a task end point of a task to be executed by an autonomous mobile machine; performing path planning for the task to obtain an initial path; determining a sub-path that does not conform to a preset constraint condition in the initial path; re-performing path planning for the sub-path that does not conform to the preset constraint condition to obtain a re-planned sub-path; and splicing a sub-path that conforms to the preset constraint condition in the initial path and the re-planned sub-path to obtain a task path. On the one hand, automatic path planning without manual participation is implemented, thereby improving efficiency and reducing manual costs. On the other hand, path planning is re-performed in a “segment” manner on a sub-path that does not conform to a preset constraint condition, thereby providing more reasonable path planning and improving calculation efficiency.

### CROSS-REFERENCE TO RELATED APPLICATIONS

The present disclosure claims priority to Chinese Patent Application No. 202510126358.7, filed on Jan. 27, 2025, the content of which is incorporated herein by reference in its entirety.

### TECHNICAL FIELD

The present disclosure relates to the field of intelligent control technologies, and in particular, to a path planning method, a controller and an autonomous mobile machine.

### BACKGROUND

A system that uses an autonomous mobile machine such as an automated guided vehicle (AGV) has advantages such as being highly unmanned, automated, and intelligent, which improves production efficiency and an operational level in industries such as warehousing, manufacturing, and logistics. In one of relatively typical scenarios, the autonomous mobile machine is usually responsible for handling tasks, mainly including loading/unloading, for a cargo container transportation vehicle such as a container truck or a container ship. For example, cargo is moved from a temporary storage area to a container truck compartment, or from a container truck compartment to a temporary storage area.

Since a space of the cargo container transportation vehicle is limited and a docking position and a docking pose of the cargo container transportation vehicle differ each time, in order to avoid a collision, reasonable path planning for autonomous mobile machines becomes a problem to be urgently solved.

### SUMMARY

In view of this, the present disclosure provides a path planning method, a controller and an autonomous mobile machine, so as to perform more reasonable path planning for the autonomous mobile machine.

According to a first aspect, a path planning method is provided and is executed by a processor. The method includes: determining a task start point and a task end point of a task to be executed by an autonomous mobile machine; performing path planning for the task to obtain an initial path; determining a sub-path that does not conform to a preset constraint condition in the initial path; re-performing path planning for the sub-path that does not conform to the preset constraint condition to obtain a re-planned sub-path; and splicing a sub-path that conforms to the preset constraint condition in the initial path and the re-planned sub-path to obtain a task path.

Optionally, the performing path planning for the task to obtain the initial path includes: starting from the task start point, performing path segment search based on a map to obtain a path segment sequence with the shortest path to the end point and taking the path segment sequence as the initial path, where a range of the map covers at least the task start point and the task end point.

Optionally, the task is a handling task, and one of the task start point and the task end point is a storage location on a cargo container transportation vehicle; and the map is obtained after the autonomous mobile machine scans and maps the cargo container transportation vehicle by using a sensor carried by the autonomous mobile machine.

Optionally, the performing path planning for the task to obtain the initial path includes: starting from the task start point, performing path segment search based on a map to obtain a path segment sequence with the shortest path to the task end point and conforming to a constraint of a first collision detection model, and taking the path segment sequence as the initial path.

Optionally, the first collision detection model includes a circular collision detection model.

Optionally, the path segment sequence conforms to the constraint of the circular collision detection model includes: the path segment in the path segment sequence not intersecting with a target contour, where the target contour is obtained by expanding a contour of an obstacle outward by a preset length, the preset length is a radius of a maximum inscribed circle within an orthographic projection, on a ground plane, of the autonomous mobile machine.

Optionally, after obtaining the re-planned sub-path, the method further includes: determining whether the re-planned sub-path conforms to the preset constraint condition; if yes, performing the step of splicing the sub-path that conforms to the preset constraint condition in the initial path and the re-planned sub-path; otherwise, re-performing path planning for the sub-path that does not conform to the preset constraint condition.

Optionally, the sub-path that does not conform to the preset constraint condition includes at least one of the following: a sub-path that does not conform to a kinematic constraint of the autonomous mobile machine; a sub-path that does not conform to a constraint of a second collision detection model; a sub-path where the task start point is located, and a difference between an orientation of the sub-path where the task start point is located and an orientation of the autonomous mobile machine at the task start point exceeds a first angle threshold; and a sub-path where the task end point is located, and a difference between an orientation of the sub-path where the task end point is located and a target orientation of the autonomous mobile machine at the task end point exceeds a second angle threshold.

Optionally, the second collision detection model includes a capsule collision detection model.

Optionally, the sub-path that does not conform to the constraint of the capsule collision detection model is determined in the following manner: when the autonomous mobile machine is simulated as a capsule shape moving on the sub-path, and the capsule shape is composed of a rectangle and semicircles at two ends of the rectangle, determining whether a distance between a centerline of the rectangle and a contour of the obstacle is greater than a radius of a maximum inscribed circle of the rectangle, and if not, determining that the sub-path does not conform to the capsule collision detection model.

Optionally, before determining whether the distance between the centerline of the rectangle and the contour of the obstacle is greater than the radius of the maximum inscribed circle of the rectangle, the method further includes: determining whether a distance between a midpoint of the rectangle and the contour of the obstacle is greater than a radius of a circumscribed circle of the rectangle, and if yes, determining that the sub-path conforms to the capsule collision detection model.

Optionally, the determining whether the distance between the centerline of the rectangle and the contour of the obstacle is greater than the radius of the maximum inscribed circle of the rectangle, if not, determining that the sub-path does not conform to the capsule collision detection model includes: determining whether the centerline of the rectangle intersects with a target contour; if yes, determining that the sub-path does not conform to the capsule collision detection model, where the target contour is obtained by expanding a contour of an obstacle outward by a preset length, and the preset length is the radius of the maximum inscribed circle.

Optionally, before determining the sub-path that does not conform to the preset constraint condition in the initial path, the method further includes: determining at least one segment point in the initial path, and segmenting the initial path at a position of the at least one segment point to obtain a plurality of sub-paths; where the segment point includes at least one of a narrow point, an entrance position point of a narrow segment, an exit position point of the narrow section and position points at a preset length interval, and the narrow point is a position point whose passage width is less than or equal to a first width threshold in the initial path, and the narrow segment is a path segment whose passage width is less than or equal to a second width threshold in the initial path.

Optionally, the re-performing path planning for the sub-path that does not conform to the preset constraint condition to obtain the re-planned sub-path includes: starting from a start point of the sub-path that does not conform to the preset constraint, performing path segment search based on a map to obtain a path segment sequence that reaches an end point of the sub-path and with a minimum value of a cost function, and taking the path segment sequence as the re-planned sub-path, where a range of the map covers at least the task start point and the task end point; where the value of the cost function is obtained according to one or any combination of a total length of sub-paths, an orientation change between path segments, a quantity of cusps, a distance between a path segment and an obstacle, and a change of a rudder angle between path segments, and the cusps refer to positions for switching forward and backward.

Optionally, in a search process, when a distance between a searched current position and the end point of the sub-path is less than or equal to a preset distance threshold, the re-planned sub-path is obtained by following steps: connecting the current position with the end point of the sub-path by using a RS curve, and splicing a searched path segment and a curve connected by using the RS curve to form the re-planned sub-path.

Optionally, the splicing the searched path segment and the curve connected by using the RS curve to form the re-planned sub-path includes: when the connecting the current position with the end point of the sub-path by using the RS curve fails, backtracking forward a preset distance from the current position according to a searched path segment sequence, taking a backtracked position as the current position, and continuing to perform the step of connecting the current position with the end point of the sub-path by using the RS curve until a backtracking end condition is met; and when the connecting the current position with the end point of the sub-path by using the RS curve succeeds, splicing the searched path segment sequence and the curve connected by using the RS curve to form the re-planned sub-path.

Optionally, the backtracking forward the preset distance includes: backtracking forward a distance corresponding to a preset quantity of action nodes, and the action nodes are moving actions performed by the autonomous mobile machine on the searched path segment sequence; and a backtracking end condition includes: a total quantity of backtracking action nodes conforming to a preset quantity threshold.

Optionally, the processor is disposed in a controller, and the method further includes: sending the task path to the autonomous mobile machine for the autonomous mobile machine to execute the task based on the task path.

According to a second aspect, a controller is provided, including a processor and a memory, where the memory is configured to store program instructions, and the processor is configured to execute the program instructions, to implement the method according to any one of the first aspect.

According to a third aspect, an autonomous mobile machine is provided, including a processor and a memory, where the memory is configured to store program instructions, and the processor is configured to execute the program instructions, to implement the method according to any one of the first aspect.

### BRIEF DESCRIPTION OF THE DRAWINGS

To describe the technical solutions in the embodiments of the present disclosure or the prior art more clearly, the following briefly describes the accompanying drawings required for describing the embodiments. Obviously, the accompanying drawings in the following description show merely some embodiments of the present disclosure, and a person skilled in the art may still derive other drawings from these accompanying drawings without creative efforts.

FIG. 1 is a diagram of a system architecture applicable to an embodiment of the present disclosure.

FIG. 2 is a flowchart of a path planning method according to an embodiment of the present disclosure.

FIG. 3 is a schematic diagram of a working area for executing a handling task according to an embodiment of the present disclosure.

FIG. 4 is a schematic diagram of simulating an autonomous mobile machine as a capsule according to an embodiment of the present disclosure.

FIG. 5 is an example diagram of an initial path according to an embodiment of the present disclosure.

FIG. 6 is a schematic block diagram of an electronic device according to an embodiment of the present disclosure.

### DETAILED DESCRIPTION OF THE EMBODIMENTS

The following clearly describes the technical solutions in embodiments of the present disclosure with reference to the accompanying drawings in embodiments of the present disclosure. Apparently, the described embodiments are merely some but not all of embodiments of the present disclosure. All other embodiments obtained by persons of ordinary skill in the art based on the embodiments of the present disclosure shall fall within the protection scope of the present disclosure.

Terms used in embodiments of the present disclosure are merely intended to describe particular embodiments but are not intended to limit the present disclosure. The singular forms of “a/an”, “said”, and “the” used in embodiments of the present disclosure and the appended claims are also intended to include plural forms, unless the context clearly implies otherwise.

It should be understood that, the term “and/or” used in this specification is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

Depending on the context, for example, the word “if” used herein may be explained as “while” or “when” or “in response to determining” or “in response to detecting”. Similarly, depending on the context, phrases “if determining” or “if detecting (a stated condition or event)” may be explained as “when determining” or “in response to determining” or “when detecting (the stated condition or event)” or “in response to detecting (the stated condition or event)”.

For ease of understanding, the relevant terms are explained below.

Processor: it is responsible for executing core functions such as calculation, control and decision-making. It may receive data from a sensor, run control algorithms, and command an actuator to complete a task. Common processor types may include: a central processing unit (CPU), a digital signal processor (DSP), a microcontroller unit (MCU), and so on. The processor in the specification may refer to a collection of processors for performing the same or different tasks.

Memory: it is configured to store data or a program. A memory in the specification may be referred to as a collection of memories for performing the same or different tasks.

At present, there are mainly the following types of path planning methods for an autonomous mobile machine.

Firstly, a method of path drawing based on manual, that is, drawing each path from a handling start point to a handling end point manually. In this way, it is necessary to respectively draw paths according to different poses and conditions of loading space of cargo container transportation vehicles, which apparently consumes a lot of manpower, and results in inefficient, high-cost, highly dependent on manual experience and poor flexibility.

Secondly, planning a path from a task start point to a task end point based on a search algorithm such as A-Star. However, the path planned in this manner may not be suitable for a movement of an autonomous mobile machine in complex environments, and rationality still needs to be improved.

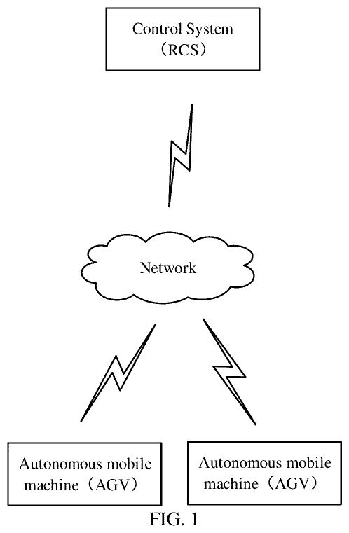

In view of this, a new approach is provided in the present disclosure. To facilitate understanding of the present disclosure, a system architecture on which the present disclosure is based is first described. FIG. 1 shows an exemplary system architecture that can be applied to embodiments of the present disclosure. As shown in FIG. 1, the system architecture may include an autonomous mobile machine and an autonomous mobile machine control system.

The autonomous mobile machine refers to a computer-controlled tool that is equipped with an electromagnetic or optical automated guided apparatus or the like, has its own power or power conversion apparatus, and is capable of automatically moving along a specified path. In embodiments of the present disclosure, the autonomous mobile machine may be mobile and may undertake specific tasks, such as transportation, and handling (including picking up and unloading). For example, the autonomous mobile machine can be an automated guided vehicle (AGV), a logistics robot, an automated guided forklift, or the like.

In an embodiment of the present disclosure, an on-board software system is installed on the autonomous mobile machine, and has a simultaneous localization and mapping (SLAM) function, a map generation function of generating a planning map based on a mapping result, a motion control function of controlling movement and operation of the autonomous mobile machine, and the like.

The autonomous mobile machine control system (RCS) may be set up on a server and is responsible for scheduling each autonomous mobile machine, including task allocation, path planning, and instruction delivery. The details can refer to related records in subsequent embodiments.

The autonomous mobile machine control system may be set up on an independent server, a server group, or a cloud server. The cloud server, also referred to as a cloud computing server or a cloud host, is a host product in a cloud computing service system, to solve defects of difficult management and weak service scalability in conventional physical hosts and virtual private server (VPS) services. In addition, the autonomous mobile machine control system may also be set up on a computer terminal with strong computing power.

It should be understood that a quantity of autonomous mobile machines and autonomous mobile machine control systems (RCSs) in FIG. 1 is merely an example. Depending on implementation requirements, there may be any quantity of autonomous mobile machines and control systems.

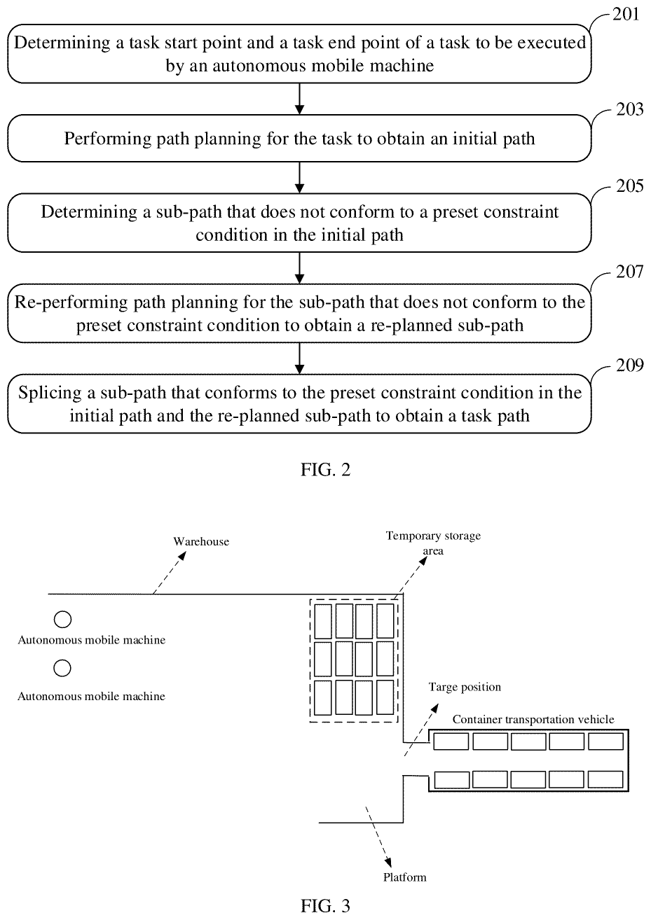

FIG. 2 is a flowchart of a path planning method according to an embodiment of the present disclosure. The method may be executed by a processor. The processor may be disposed on RCS in a system shown in FIG. 1 or may be disposed on an autonomous mobile machine. As shown in FIG. 2, the method may include the following steps.

Step 201: determining a task start point and a task end point of a task to be executed by an autonomous mobile machine.

Step 203: performing path planning for the task to obtain an initial path.

Step 205: determining a sub-path that does not conform to a preset constraint condition in the initial path.

Step 207: re-performing path planning for the sub-path that does not conform to the preset constraint condition to obtain a re-planned sub-path.

Step 209: splicing a sub-path that conforms to the preset constraint condition in the initial path and the re-planned sub-path to obtain a task path.

It can be learned from the foregoing procedure that, in the present disclosure, after performing path planning based on the task start point and the task end point to obtain the initial path, the path planning will be reperformed for the sub-path that does not conform to the preset constraint condition. On the one hand, automatic path planning without manual participation is implemented, thereby improving efficiency and reducing manual costs. On the other hand, re-performing path planning in a “segment” manner for the sub-path that does not conform to a preset constraint condition, thereby providing more reasonable path planning and improving calculation efficiency as much as possible.

The steps in the foregoing process and the effects that may be further generated are described in detail below with reference to embodiments. Firstly, the foregoing Step 201, that is, “determining a task start point and a task end point of a task to be executed by an autonomous mobile machine” is described in detail with reference to an embodiment.

The manner provided in the present disclosure may implement path planning for any task. In a relatively typical scenario, the autonomous mobile machine may move and transport cargo between a temporary storage area of a warehouse and a loading space of the cargo container transportation vehicle without human intervention, so as to complete loading/unloading.

To facilitate understanding, it will be briefly described the foregoing scenario with reference to FIG. 3. As shown in FIG. 3, when the autonomous mobile machine is not performing a task, the autonomous mobile machine is usually located in its own parking place, and the parking place may be a location such as a warehouse, a carport and the like. The cargo container transportation vehicle may be a truck, a cargo ship, a flying wing vehicle and the like. The cargo container transportation vehicle has a loading space, which may be a compartment, a platform, a rack and the like, and a location where cargo is placed in the loading space is referred to as a storage location (also referred to as a cargo space). The cargo container transportation vehicle is usually parked at the specific position of the platform, and a bridging position between the platform and the cargo container transportation vehicle is used for making the autonomous mobile machine board the cargo container transportation vehicle. For example, the bridging position may be a bridging position for boarding a vehicle, a bridging position for boarding a ship, etc. When the autonomous mobile machine performs a handling task, it is necessary to transport cargo of each storage location on the temporary storage area to the storage location on the cargo container transportation vehicle (that is, loading) or transport cargo of the storage location on the cargo container transportation vehicle to the storage location on the temporary storage area (that is, unloading).

When the staff determines that the cargo container transportation vehicle is parked at the platform, the staff can trigger the terminal device to send a task start instruction to the RCS by pressing a physical or virtual button on the terminal device, or inputting a command or the like. Following, the RCS generates a mapping task and sends a mapping task instruction to the autonomous mobile machine. During a process of executing the mapping task, the autonomous mobile machine scans exterior and interior of the cargo container transportation vehicle by using a sensor carried itself (for example, may include a radar such as a Lidar, a millimeter wave radar and a ToF radar, and may further include a visual sensor such as a camera), then maps a point cloud map obtained by scanning to the ground plane and performs binarization processing to obtain a planning map, and sends the planning map to the RCS. The RCS generates a handling task based on the planning map, and sends a handling task instruction to the autonomous mobile machine. When the RCS generates the handling task based on the planning map, it may be involved in planning of a transport path, and may plan the transport path by manners provided in embodiments of the present disclosure.

Therefore, in this scenario, at least one of the task start point and the task end point is a storage location on the cargo container transportation vehicle. For example, for loading tasks, the task start point is a storage location on the temporary storage area, and the task end point is a storage location on the cargo container transportation vehicle, and for unloading tasks, the task start point is the storage location on the cargo container transportation vehicle, and the task end point is the storage location on the temporary storage area.

In addition to the foregoing relatively typical handling task scenario, the embodiment of the present disclosure is also applicable to other task scenarios.

The foregoing Step 203, that is, “performing path planning for the task to obtain an initial path” will be described in detail below with reference to an embodiment.

As an implementation, starting from the task start point, path segment search is performed based on a map to obtain a path segment sequence with the shortest path to the task end point and conforming to a constraint of a first collision detection model, and the path segment sequence is taken as the initial path, and a range of the map at least covers the task start point and the task end point.

A path search algorithm, such as A-Star, may be used for performing path segment search.

When path planning is performed in this step, a first collision detection model, without considering constraints such as orientation or kinematics, may be used for simple limitation, and thus a planning speed is fast. For example, the first collision detection model may be a circular collision detection model.

Since the A-Star algorithm is a currently mature path search algorithm, details are not described herein. A circular collision detection model involved is described. In an embodiment of the present disclosure, the initial path obtained by searching essentially consists of a path segment sequence. Each path segment in the path segment sequence needs to conform to a constraint of the circular collision detection model to avoid collision with obstacles. For the autonomous mobile machine, an orthographic projection on the ground plane is a rectangle, and the autonomous mobile machine is simulated as a rectangle. In this case, the autonomous mobile machine does not collide with the obstacle in a moving process, which is equivalent to expanding the obstacle contour outward by a preset length to obtain a target contour, where the preset length is a radius of a maximum inscribed circle of the autonomous mobile machine. The maximum inscribed circle of the rectangle refers to a circle that is tangent to two opposite long sides of the rectangle. If none of the path segments in the path segment sequence intersects with the target contour, it means that no collision occurs with the obstacle when the autonomous mobile machine moves on the path segments.

It should be noted herein that the purpose of considering the circular collision detection model in the initial path is to make an approximate limitation without considering the orientation of the autonomous mobile machine, so that the initial path can be efficiently obtained. In addition to the circular collision detection model, other collision detection models may also be used as the first collision detection model for constraint.

After obtaining the initial path, smoothing processing may be further performed on the initial path. A manner used for smoothing processing may include, for example, arc approximation processing of inflection points, curve fitting processing, filter-based smoothing processing, curve interpolation processing and solving a smoothing path using a gradient descent method.

The foregoing Step 205, that is, “determining a sub-path that does not conform to a preset constraint condition in the initial path” will be described in detail with reference to an embodiment.

This step is essentially to find “unreasonable” sub-paths in the initial path. In an embodiment of the present disclosure, the initial path is segmented at first, including: determining at least one segmentation point in the initial path, and segmenting the initial path at a position of the segmentation point to obtain a plurality of sub-paths.

As an implementable segmentation manner, the segment may be performed based on a narrow point in the initial path, where the narrow point is a position point whose passage width is less than or equal to a first width threshold in the initial path, and the first width threshold is generally determined according to a size of the autonomous mobile machine.

As another implementable segmentation manner, the segment may be performed based on an entrance position point and an exit position point of a narrow segment in the initial path, where the narrow segment is a path segment whose passage width is less than or equal to a second width threshold in the initial path, and the second width threshold is generally determined according to the size of the autonomous mobile machine. For example, as shown in FIG. 5, it is assumed that there is a narrow segment (for example, a narrow passage), and an orientation of an entrance position and an exit position of the narrow segment are constrained, so that the initial path may be segmented by using the entrance position and the exit position of the narrow segment as segment points separately.

As still another implementable segmentation manner, the initial path may be segmented based on a preset length interval, that is, position points at the preset length interval in the initial path are used as segment points to obtain each sub-path.

The foregoing three implementable segmentation manners may be used alternatively, or all may be used to segment the initial path.

The foregoing sub-path that does not conform to the preset constraint condition may include, but are not limited to, several types.

The first type: a sub-path that does not conform to a kinematics constraint of the autonomous mobile machine.

The kinematics constraint refers to a physical constraint that need to be met when the autonomous mobile machine moves along a path, such as speed, acceleration, and steering capability.

For example, whether a rotation angle of the sub-path matches a steering capability of the autonomous mobile machine. If a rotation radius of the sub-path is too small and exceeds the steering capability of the autonomous mobile machine, the sub-path does not conform to the kinematics constraint of the autonomous mobile machine, so the sub-path is an unreasonable path.

The second type: a sub-path that does not conform to a constraint of a second collision detection model.

As an embodiment of the present disclosure, compared with the first collision detection model, the second collision detection model has a stronger constraint, and an orientation of the autonomous mobile machine is generally further considered.

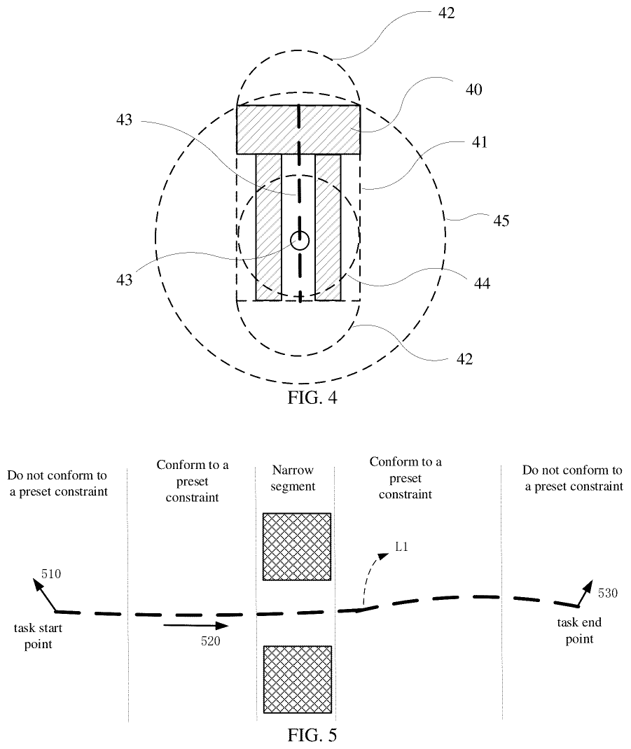

Specifically, the second collision detection model may be a capsule collision detection model. Compared with the circular collision detection model, the capsule collision detection model further considers the orientation of the autonomous mobile machine, which means a more rigorous constraint. If considering a constraint of the capsule collision detection model, the autonomous mobile machine may be simulated as a capsule shape that moves on the sub-path. As shown in FIG. 4, the capsule shape includes a rectangle 41 and semicircles 42 at both ends of the rectangle. The rectangle 41 is a rectangular area obtained by projecting the autonomous mobile machine 40 on a ground plane, and a diameter of each of the two semicircles 42 is equal to a length of a short side of the rectangle 41. A rectangle centerline 43 along a direction of a long side of the rectangle 41 may be understood as an orientation of the autonomous mobile machine 40 on a map plane. Therefore, it may be determined whether a distance between the centerline 43 of the rectangle 41 and an obstacle contour is greater than a radius of a maximum inscribed circle 44 of the rectangle, where the maximum inscribed circle 44 refers to a circle whose radius is tangent to two opposite long sides of the rectangle 41. If no, determining that the sub-path does not conform to the capsule collision detection model, which means that the autonomous mobile machine 40 will collide with the obstacle when moving on the sub-path.

As an implementation, when it is determined whether the distance between the centerline of the rectangle 41 and the obstacle contour is greater than the radius of the maximum inscribed circle 44 of the rectangle, it may be first determined whether the centerline 43 of the rectangle 41 intersects with the target contour. The target contour is obtained by expanding the obstacle contour outward by a preset length, and the preset length is the radius of the maximum inscribed circle 44 of the autonomous mobile machine 40. If the centerline 43 of the rectangle 41 intersects with the target contour, the sub-path does not conform to the capsule collision detection model, which means that the autonomous mobile machine 40 will collide with the obstacle when moving on the sub-path, and the sub-path is unreasonable.

As a more preferred detection manner, in an embodiment of the present disclosure, when it is used the capsule collision detection model to detect, it may be first detected whether a distance between a midpoint of the rectangle 41 and the obstacle is greater than a radius of a circumscribed circle 45 of the rectangle 41, where the circumscribed circle 45 of the rectangle 41 may be formed by taking a midpoint of a line connecting two directional wheels of the autonomous mobile machine as a center and taking a straight line distance between the midpoint and the farthest point on the rectangle from the center as a radius. If the distance between the midpoint of the rectangle 41 and the obstacle is greater than the radius of the circumscribed circle 45 of the rectangle 41, it may be directly determined that the autonomous mobile machine 40 will not collide with the obstacle, and the sub-path is reasonable. Otherwise, it may be further detected whether the distance between the centerline 43 of the rectangle 41 and the obstacle contour is greater than the radius of the maximum inscribed circle 44 of the rectangle 41. If not, it is determined that the autonomous mobile machine 40 will collide with the obstacle, and the sub-path is unreasonable, and if the distance between the centerline 43 of the rectangle 41 and the obstacle contour is greater than the radius of the maximum inscribed circle 44 of the rectangle 41, it is determined that the autonomous mobile machine 40 will not collide with the obstacle, and the sub-path is reasonable.

The third type: a sub-path where the task start point is located, where a difference between an orientation of the sub-path where the task start point is located and an orientation of the autonomous mobile machine at the task start point exceeds a first angle threshold.

That is, if the difference between the orientation of the sub-path where the task start point is located and the orientation of the autonomous mobile machine at the task start point exceeds the first angle threshold, it is determined that the sub-path where the task start point is located is a sub-path that does not conform to the preset constraint condition.

If there is a difference between the orientation of the sub-path where the task start point is located and the orientation of the autonomous mobile machine at the task start point, it means that if the autonomous mobile machine hopes to drive normally on the sub-path where the task start point is located, it needs to adjust its orientation. However, in some cases, it is relatively difficult to adjust the orientation of the autonomous mobile machine in place, so it may be considered that the sub-path where the task start point is located is unreasonable in this case.

The foregoing first angle threshold may be 0 or may be take a value greater than 0.

The fourth type: a sub-path where the task end point is located, and a difference between an orientation of the sub-path where the task end point is located and a target orientation of the autonomous mobile machine at the task end point exceeds a second angle threshold.

That is, if the difference between the orientation of the sub-path where the task end point is located and the target orientation of the autonomous mobile machine at the task end point exceeds the second angle threshold, it is determined that the sub-path where the task end point is located is a sub-path that does not conform to the preset constraint condition.

If there is a difference between the orientation of the sub-path where the task end point is located and the target orientation of the autonomous mobile machine at the task end point (for example, an orientation that is suitable for handling cargo to the target storage location on the loading space of the cargo container transportation vehicle), it means that the autonomous mobile machine needs to adjust its orientation to the target orientation at the task end point. However, in some cases, it is relatively difficult to adjust the orientation of the autonomous mobile machine in place, so it may be considered that the sub-path where the task start point is located is unreasonable in this case.

The foregoing second angle threshold may be 0 or may be take a value greater than 0.

Taking the initial path shown in FIG. 5 as an example, the initial path from a task start point to a task end point is formed by path segments L1 in the figure. The initial path may be segmented according to a preset length interval, and since a narrow segment, whose passage width is less than or equal to a width threshold, is caused by an obstacle in the middle part, and the passage space is narrow, it may be separately segmented at an entrance position and an exit position of the narrow segment to obtain a plurality of sub-paths. The arrow 510 indicates the orientation of the autonomous mobile machine at the task start point, the arrow 520 indicates the orientation of the initial path and the arrow 530 indicates the target orientation of the autonomous mobile machine at the task end point. An orientation difference between the orientation of a sub-path where the task start point is located and the orientation of the autonomous mobile machine at the task start point exceeds the first angle threshold, so the sub-path where the task start point is located is determined as a sub-path segment that does not conform to a preset constraint. A target orientation difference between the orientation of the sub-path where the task end point is located and the target orientation of the autonomous mobile machine at the task end point exceeds the second angle threshold. Therefore, the sub-path in which the task end is located is determined as a sub-path segment that does not conform to a preset constraint.

The foregoing Step 207, that is, “re-performing path planning for the sub-path that does not conform to the preset constraint condition to obtain a re-planned sub-path” will be described in detail below with reference to an embodiment.

In this step, path planning is re-performed for the sub-path that does not conform to the preset constraint condition, that is, for each sub-path that does not conform to the preset constraint condition, a path segment search, based on a map, is performed from a start point of the sub-path to obtain a path segment sequence that reaches an end point of the sub-path and with a minimum value of a cost function, and the path segment sequence is taken as a re-planned sub-path.

The foregoing path segment search may be performed by using a Hybrid A-Star algorithm. The Hybrid A-Star algorithm is an improved path planning algorithm, which is based on the traditional A-Star algorithm but adds consideration to the kinematics constraint of the autonomous mobile machine. Specifically, the Hybrid A-Star algorithm adds a heading angle dimension, so that search space is expanded from two-dimensional to three-dimensional. This means that not only the position but also the orientation should be considered when searching path segment in a planning map, so as to better satisfy the kinematics constraint of the autonomous mobile machine.

Because the heading angle dimension is added to the Hybrid A-Star algorithm, a relatively large computation amount is required, and in particular, more computing resources are required in a complex environment. However, in an embodiment of the present disclosure, path planning is performed only for a determined sub-path that does not conform to a preset constraint condition by using the Hybrid A-Star algorithm, which reduces the consumption of the computing resource as much as possible to ensure computation efficiency while ensuring overall rationality and security of the path.

In an embodiment of the present disclosure, the Hybrid A-Star algorithm is further improved.

As an improvement manner, a resolution of a state space used by the Hybrid A-Star algorithm is improved. The higher the resolution of the state space, the greater the computational complexity. To strike a balance between path quality and calculation efficiency, in an application scenario of the embodiment of the present disclosure, a centimeter-level resolution may be used in a two-dimensional dimension of a position, for example, a resolution of 0.05 meters, that is, taking 0.05 m as a length of a grid, and taking \sqrt{2}×0.05 meters as a search step to obtain a path segment. A relatively low resolution is used in the heading angle dimension, such as 90°, and may also be extended to 45°.

Correspondingly, in a case in which the foregoing resolution is used, an action space of the autonomous mobile machine can be discretized. For example, six atomic actions may be used: forward in a straight line \sqrt{2}×0.05 meters, turn left 90°, turn right 90°, and reverse actions of the three atomic actions.

The value of the cost function is obtained according to one or any combination of the total length of sub-paths, an orientation change between path segments, a quantity of cusps, a distance between a path segment and an obstacle, and a change of a rudder angle between path segments, and the cusps are positions for switching forward and backward.

As another improvement, a new cost function is adopted for the Hybrid A-Star algorithm, which is obtained according to one or any combination of a total length of sub-paths, an orientation change between path segments, a quantity of cusps, a distance between a path segment and an obstacle, and a change of a rudder angle between path segments.

For example, the cost function J may be defined as follows:

$$J = {w}_{1} \cdot {J}_{l e ngth} + {w}_{2} \cdot {J}_{obstacle} + {w}_{3} \cdot {J}_{turn \_ angle} + {w}_{4} \cdot {J}_{steer \_ angle} + {w}_{5} \cdot {J}_{c u s p} . \qquad ( 1 )$$

Where w₁, w₂, w₃, w₄ and w₅ are weighting coefficients, and may be an empirical value or an experimental value.

J_{length} refers to a cost item related to the length of the sub-path, and the cost item encourages planning of the shortest sub-path. In addition, considering that a speed of the autonomous mobile machine is slow when the autonomous mobile machine reversing, a relatively high penalty may be imposed on a length of a reversing path, so as to avoid an unnecessary reversing path. For example,

$${J}_{length} = \sum {d}_{i} . \qquad ( 2 )$$

dᵢ indicates a moving distance corresponding to each step of search and a length of each path segment. The moving distance corresponding to reversing may be a negative value.

J_{obstacle} is a cost item related to a distance between a path segment and an obstacle, and the cost item is used to ensure a safe distance between the sub-path and the obstacle, so as to improve robustness of the path. For example,

$${J}_{obstacle} = \sum {c}_{i} . \qquad ( 3 )$$

cᵢ indicates a cost of a distance between each path segment and the obstacle. If the distance between the path segment i and the obstacle is greater than the safe distance, cᵢ takes a positive value. Otherwise, cᵢ takes a negative value.

J_{turn_angle} refers to a cost item related to the orientation change between the path segments, and the cost item is used to penalize a path with an excessive turning angle, thereby enhancing the smoothness of the path. For example,

$${J}_{turn \_ angle} \sum {( {θ}_{i + 1} - {θ}_{i} )}^{2} . \qquad ( 4 )$$

0ᵢ indicates an angle between a path segment i and a reference orientation. All path segments use a uniform reference orientation, so θᵢ₊₁−θᵢ indicates an orientation change between adjacent path segments.

J_{steer_angle} refers to a cost item related to a change of a rudder angle between path segments. The cost item is used to penalize a path with excessive change of the rudder angle, so as to reduce excessive rotation of a steering wheel of the autonomous mobile machine and improve driving stability. For example,

$${J}_{steer \_ angle} \sum {( {φ}_{i + 1} - {φ}_{i} )}^{2} \qquad ( 5 )$$

φᵢ refers to the rudder angle corresponding to the path segment i.

J_{cusp} refers to a cost item related to a quantity of cusps, a cusp refers to a position for switching forward and backward, that is, a position where the autonomous mobile machine shifts gears (from a forward gear to a reverse gear, or from a reverse gear to a forward gear). The cost item is used to penalize a path with excessive gear shifting times for autonomous mobile machine. For example,

$${J}_{cusp} = {N}_{cusp} \qquad ( 6 )$$

N_{cusp} indicates the quantity of cusps in the sub-path.

As still another improvement manner, in order to reduce an error caused by discretization, in an embodiment of the present disclosure, the sub-path may be repaired based on the Hybrid A-Star algorithm and a reeds-shepp (RS) curve. In a search process, if a distance (for example, an Euclidean distance) between a searched current position and an end point of a sub-path is less than or equal to a preset distance threshold, connecting the current position and the end point of the sub-path by using the RS curve, and splicing the searched path segment and a curve connected by using the RS curve to obtain a re-planned sub-path.

The Reeds-Shepp curve (RS curve) is developed on the basis of Dubins curve. It allows the vehicle to move forward and backward, so that in some cases, a path shorter than the Dubins curve will be found. The RS curve is composed of an arc and a straight line, and conforms to a curvature constraint in vehicle kinematics. At present, there are relatively mature algorithms and software for the calculation of the RS curve. In the embodiment of the present disclosure, existing RS curve algorithms or corresponding software interfaces may be used to connect RS curves at two locations.

If the connection between the current position and the end point of the sub-path by using the RS curve fails, backtracking forward a preset distance from the current position according to the searched path segment sequence and taking a backtracked position as the current position, and continuing to perform the step of connecting the current position with the end point of the sub-path by using the RS curve until a backtracking end condition is met.

The foregoing backtracking forward the preset distance may include: backtracking forward a distance corresponding to a preset quantity of action nodes, where the action nodes are moving actions performed by the autonomous mobile machine on the searched path segment sequence, and the moving actions may be one of the foregoing six atomic actions. It may backtrack a distance corresponding to one action node each time, or backtrack a distance corresponding to multiple action nodes each time.

If the connection between the current position and the end point of the sub-path by using the RS curve succeeds, the re-planned sub-path can be obtained by splicing the searched path segment and a curve connected by using the RS curve.

In the embodiment of the present disclosure, the foregoing backtracking end condition may include that a total quantity of backtracking action nodes conforming to a preset quantity threshold. If a quantity of backtracking action nodes conforms to the preset quantity threshold, the RS curve may be abandoned for a current sub-path, and the Hybrid A-Star algorithm will used to search the path to the end point of the sub-path.

Further, in an embodiment of the present disclosure, an RS curve obtained by connecting may be optimized, so as to filter out RS curves including cusps or forming a double circular arc.

The foregoing Step 209, that is, “Splicing a sub-path that conforms to the preset constraint condition in the initial path and the re-planned sub-path to obtain a task path” will be described in detail below with reference to the embodiment.

As an implementation, the task path is obtained by directly splicing the sub-path that conforms to the preset constraint condition in the initial path and the re-planned sub-path.

However, in this implementation, there may be still unreasonable re-planned sub-paths. Therefore, the embodiment of the present disclosure provides another more preferred implementation, that is, it is determined whether all the re-planned sub-paths conform to the preset constraint condition. If yes, a step of splicing sub-paths that conform to the preset constraint condition and re-planned sub-paths in the initial path will be performed, otherwise, path planning is re-performed on sub-paths, among the re-planned sub-paths, that do not conform to the preset constraint condition until all the re-planned sub-paths conform to the preset constraint condition, or the quantity of times of re-planning reaches a preset quantity threshold.

In an application scenario, the foregoing task is a handling task, and one of the task start point and the task end point is a storage location on a cargo container transportation vehicle. After obtaining the task path, the task path may be sent to the autonomous mobile machine by carrying the task path in a corresponding task instruction. For example, in a handling task scenario, information about a task path generated for the handling task is carried in the handling task instruction, and sent to the autonomous mobile machine by the RCS, then the autonomous mobile machine moves and executes the corresponding handling task according to the task path.

Particular embodiments of this specification are described above. Other embodiments fall within the scope of the claims. In some cases, the actions or steps described in the claims may be performed in an order different from that in embodiments while still achieving expected results. In addition, the processes depicted in the accompanying drawings do not necessarily require the particular order shown or a sequential order to achieve expected results. In some implementations, multitasking and parallel processing are also possible or may be advantageous.

It should be noted that the user information (including but not limited to user equipment information, the user personal information, and the like) and data (including but not limited to data used for analysis, stored data and displayed data) involved in the present disclosure are information and data that are authorized by the user or are fully authorized by each party, and collection, use and processing of the related data needs to comply with relevant laws and standards of relevant countries and regions, and a corresponding operation entry is provided for the user to choose to authorize or reject.

In addition, an embodiment of the present disclosure further provides a computer-readable storage medium, where the computer-readable storage medium stores a computer program. When the computer program is executed by a processor, the steps of the method in any one of the foregoing method embodiments are implemented.

An embodiment of the present disclosure further provides a controller, including a processor. The processor is configured to execute program instructions to implement the steps of the method in any one of the foregoing method embodiments.

An embodiment of the present disclosure further provides an autonomous mobile machine, including: a processor. The processor is configured to execute program instructions to implement the steps of the method in any one of the foregoing method embodiments.

The present disclosure further provides a computer program product, including a computer program. When the computer program processor is executed by a processor, the steps of the method in any one of the foregoing method embodiments are implemented.

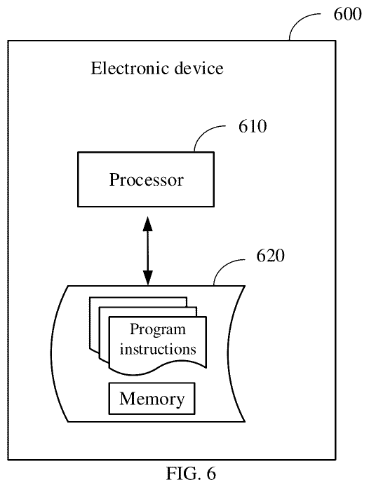

FIG. 6 exemplarily shows a schematic composition diagram of an electronic device (which may be the foregoing controller or the autonomous mobile machine). As shown in FIG. 6, the electronic device 600 includes a memory 620 and a processor 610.

The memory 620 is configured to store a program instruction.

The processor 610 is coupled to the memory 620 and configured to read the program instruction stored in the memory 620 to perform the steps of the method according to any one of the foregoing method embodiments.

In some embodiments, the processor 610 may be one or more. The foregoing program instructions may be executed by using a general-purpose CPU, a microprocessor, an application-specific integrated circuit (ASIC), one or more integrated circuits, and the like, to implement the technical solutions provided in the present disclosure.

The memory 620 may be implemented in a form of a read only memory (ROM), a random access memory (RAM), a static storage device, a dynamic storage device, and the like.

It should be noted that although the foregoing electronic device shows only the memory 620, the processor 610, however, in a specific implementation process, the electronic device may further include other components necessary to implement normal operation. In addition, person skilled in the art shall understand that the foregoing electronic device may include only components necessary to implement the solutions of the present disclosure, and not necessary to include all components shown in drawings.

Embodiments in this specification are all described in a progressive manner, for the same or similar parts in the embodiments, mutual reference may be made, and each embodiment focuses on what is different from other embodiments. In particular, the system and apparatus embodiment are basically similar to a method embodiment, and therefore are described briefly, and the related parts may refer to the descriptions of the method embodiments. The foregoing described system and apparatus embodiment are merely exemplary. The units described as separate parts may be or may not be physically separate, and parts displayed as units may be or may not be physical units, that is, may be located at one position, or may be distributed on multiple network units. Some or all of the modules may be selected according to an actual requirement to achieve the objectives of the solutions of the embodiments. A person of ordinary skill in the art may understand and implement the present disclosure without creative efforts.

According to specific embodiments provided in the present disclosure, the present disclosure discloses the following technical effects.

Firstly, in the present disclosure, after performing path planning based on a task start point and a task end point to obtain an initial path, the path planning will be reperformed for a sub-path that does not conform to a preset constraint condition. On the one hand, automatic path planning without manual participation is implemented, thereby improving efficiency and reducing manual costs. On the other hand, path planning is re-performed in a “segment” manner on a sub-path that does not conform to a preset constraint condition, thereby providing more reasonable path planning and improving calculation efficiency as much as possible.

Secondly, according to the present disclosure, when the initial path is generated, search is performed only based on the shortest path and a constraint of a circular collision detection model, thereby improving the efficiency of path planning and reducing calculation pressure on the basis of meeting a basic security requirement.

Thirdly, according to the present disclosure, multiple factors such as the kinematics constraint, the constraint of the capsule collision detection model, orientation constraint and the like are fully considered to find unreasonable sub-paths for re-performing path planning, so as to ensure security and rationality of the task path more comprehensively and accurately.

Fourthly, according to the present disclosure, when re-performing path planning for sub-paths that do not conform to the preset constraint condition, multi-dimensional factors such as a total length, an orientation change between path segments, a quantity of cusps, a distance between a path segment and an obstacle, and a change of a rudder angle between path segments are considered in a cost function, and a balance is implemented among these multi-dimensional factors, thereby re-planning a path more smooth, stable, safe and efficient.

Fifthly, according to the present disclosure, in a process of re-planning sub-paths, path repair may be performed by using the RS curve, thereby reducing an error caused by discretization processing in a search process and improving a smoothness of the sub-paths obtained by re-planning, further making autonomous mobile machines move more efficiently, smoothly, and stably in a task execution process.

Lastly, the present disclosure is applicable to performing a transport task of the cargo container transportation vehicle by using autonomous mobile machines. Even if a docking position and a docking pose of the cargo container transportation vehicle are different each time, an efficient, safe and reasonable task path can be generated.

Certainly, any invention of the present disclosure does not necessarily need to achieve all of the advantages described above.

The technical solutions provided in the present disclosure are described above in detail. The principles and implementations of the present disclosure are described herein by using specific examples. The descriptions about embodiments are merely provided to help understand the methods and core ideas of the present disclosure. In addition, a person of ordinary skill in the art may make variations to the present disclosure in terms of the specific implementations and application scopes according to the idea of the present disclosure. In conclusion, the content of this specification shall not be construed as a limitation on the present disclosure.

1. A path planning method, executed by a processor, comprising:
determining a task start point and a task end point of a task to be executed by an autonomous mobile machine;
performing path planning for the task to obtain an initial path;
determining a sub-path that does not conform to a preset constraint condition in the initial path;
re-performing path planning for the sub-path that does not conform to the preset constraint condition to obtain a re-planned sub-path, determining whether the re-planned sub-path conforms to the preset constraint condition; if yes, performing the step of splicing the sub-path that conforms to the preset constraint condition in the initial path and the re-planned sub-path; otherwise, re-performing path planning for the sub-path that does not conform to the preset constraint condition until all the re-planned sub-paths conform to the preset constraint condition or a quantity of times of re-planning reaches a preset quantity threshold; and
splicing a sub-path that conforms to the preset constraint condition in the initial path and the re-planned sub-path to obtain a task path before controlling the autonomous mobile machine to move, and controlling the autonomous mobile machine to move and execute a corresponding handling task according to the task path, wherein before determining the sub-path that does not conform to the preset constraint condition in the initial path, the method further comprises:
determining at least one segment point in the initial path, and segmenting the initial path at a position of the at least one segment point to obtain a plurality of sub-paths;
wherein the segment point comprises at least one of a narrow point, an entrance position point of a narrow segment, an exit position point of the narrow segment and position points at a preset length interval.

2. The method according to claim 1, wherein the performing path planning for the task to obtain the initial path comprises:
starting from the task start point, performing path segment search based on a map to obtain a path segment sequence with the shortest path to the end point and taking the path segment sequence as the initial path, wherein a range of the map covers at least the task start point and the task end point.

3. The method according to claim 2, wherein the task is a handling task, and one of the task start point and the task end point is a storage location on a cargo container transportation vehicle; and
the map is obtained after the autonomous mobile machine scans and maps the cargo container transportation vehicle by using a sensor carried by the autonomous mobile machine.

4. The method according to claim 1, wherein the performing path planning for the task to obtain the initial path comprises:
starting from the task start point, performing path segment search based on a map to obtain a path segment sequence with the shortest path to the task end point and conforming to a constraint of a first collision detection model, and taking the path segment sequence as the initial path.

5. The method according to claim 4, wherein the first collision detection model comprises a circular collision detection model.

6. The method according to claim 5, wherein the path segment sequence conforms to the constraint of the circular collision detection model comprises:
the path segment in the path segment sequence not intersecting with a target contour, wherein the target contour is obtained by expanding a contour of an obstacle outward by a preset length, the preset length is a radius of a maximum inscribed circle within an orthographic projection, on a ground plane, of the autonomous mobile machine.

7. (canceled)

8. The method according to claim 1, wherein the sub-path that does not conform to the preset constraint condition comprises at least one of the following:
a sub-path that does not conform to a kinematic constraint of the autonomous mobile machine;
a sub-path that does not conform to a constraint of a second collision detection model;
a sub-path where the task start point is located, and a difference between an orientation of the sub-path where the task start point is located and an orientation of the autonomous mobile machine at the task start point exceeds a first angle threshold; and
a sub-path where the task end point is located, and a difference between an orientation of the sub-path where the task end point is located and a target orientation of the autonomous mobile machine at the task end point exceeds a second angle threshold.

9. The method according to claim 8, wherein the second collision detection model comprises a capsule collision detection model.

10. The method according to claim 9, wherein the sub-path that does not conform to the constraint of the capsule collision detection model is determined in the following manner:
when the autonomous mobile machine is simulated as a capsule shape moving on the sub-path, and the capsule shape is composed of a rectangle and semicircles at two ends of the rectangle, determining whether a distance between a centerline of the rectangle and a contour of the obstacle is greater than a radius of a maximum inscribed circle of the rectangle, and if not, determining that the sub-path does not conform to the capsule collision detection model, wherein the rectangle has long sides and short sides, the centerline of the rectangle extends along an extension direction of the long sides.

11. (canceled)

12. The method according to claim 10, wherein the determining whether the distance between the centerline of the rectangle and the contour of the obstacle is greater than the radius of the maximum inscribed circle of the rectangle, if not, determining that the sub-path does not conform to the capsule collision detection model comprises:
determining whether the centerline of the rectangle intersects with a target contour; if yes, determining that the sub-path does not conform to the capsule collision detection model, wherein the target contour is obtained by expanding a contour of an obstacle outward by a preset length, and the preset length is the radius of the maximum inscribed circle.

13. The method according to claim 1, wherein the narrow point is a position point whose passage width is less than or equal to a first width threshold in the initial path, and the narrow segment is a path segment whose passage width is less than or equal to a second width threshold in the initial path.

14. The method according to claim 1, wherein the re-performing path planning for the sub-path that does not conform to the preset constraint condition to obtain the re-planned sub-path comprises:
starting from a start point of the sub-path that does not conform to the preset constraint condition, performing path segment search based on a map to obtain a path segment sequence that reaches an end point of the sub-path and with a minimum value of a cost function, and taking the path segment sequence as the re-planned sub-path, wherein a range of the map covers at least the task start point and the task end point;
wherein the value of the cost function is obtained according to one or any combination of a total length of sub-paths, an orientation changes between path segments, a quantity of cusps, a distance between a path segment and an obstacle, and a change of a rudder angle between path segments, and the cusps refer to positions for switching forward and backward.

15. The method according to claim 14, wherein in a search process, when a distance between a searched current position and the end point of the sub-path is less than or equal to a preset distance threshold, the re-planned sub-path is obtained by following steps:
connecting the current position with the end point of the sub-path by using a reeds-shepp (RS) curve, and splicing a searched path segment and a curve connected by using the RS curve to form the re-planned sub-path.

16. The method according to claim 15, wherein the splicing the searched path segment and the curve connected by using the RS curve to form the re-planned sub-path comprises:
when the connecting the current position with the end point of the sub-path by using the RS curve fails, backtracking forward a preset distance from the current position according to a searched path segment sequence, taking a backtracked position as the current position, and continuing to perform the step of connecting the current position with the end point of the sub-path by using the RS curve until a backtracking end condition is met; and
when the connecting the current position with the end point of the sub-path by using the RS curve succeeds, splicing the searched path segment sequence and the curve connected by using the RS curve to form the re-planned sub-path.

17. The method according to claim 16, wherein the backtracking forward the preset distance comprises: backtracking forward a distance corresponding to a preset quantity of action nodes, and the action nodes are moving actions performed by the autonomous mobile machine on the searched path segment sequence; and
a backtracking end condition comprises: a total quantity of backtracking action nodes conforming to a preset quantity threshold.

18. The method according to claim 1, wherein the processor is disposed in a controller, and the method further comprises:
sending the task path to the autonomous mobile machine for the autonomous mobile machine to execute the task based on the task path.

19. A controller, comprising a processor and a memory, wherein the memory is configured to store program instructions, and the processor is configured to execute the program instructions, to implement following steps:
determining a task start point and a task end point of a task to be executed by an autonomous mobile machine;
performing path planning for the task to obtain an initial path;
determining a sub-path that does not conform to a preset constraint condition in the initial path, determining whether the re-planned sub-path conforms to the preset constraint condition; if yes, performing the step of splicing the sub-path that conforms to the preset constraint condition in the initial path and the re-planned sub-path; otherwise, re-performing path planning for the sub-path that does not conform to the preset constraint condition until all the re-planned sub-paths conform to the preset constraint condition or a quantity of times of re-planning reaches a preset quantity threshold; and
re-performing path planning for the sub-path that does not conform to the preset constraint condition to obtain a re-planned sub-path; and
splicing a sub-path that conforms to the preset constraint condition in the initial path and the re-planned sub-path to obtain a task path before controlling the autonomous mobile machine to move, and controlling the autonomous mobile machine to move and execute a corresponding handling task according to the task path, wherein before determining the sub-path that does not conform to the preset constraint condition in the initial path, the method further comprises:
determining at least one segment point in the initial path, and segmenting the initial path at a position of the at least one segment point to obtain a plurality of sub-paths;
wherein the segment point comprises at least one of a narrow point, an entrance position point of a narrow segment, an exit position point of the narrow segment and position points at a preset length interval.

20. An autonomous mobile machine, comprising a processor and a memory, wherein the memory is configured to store program instructions, and the processor is configured to execute the program instructions, to implement following steps:
determining a task start point and a task end point of a task to be executed by an autonomous mobile machine;
performing path planning for the task to obtain an initial path;
determining a sub-path that does not conform to a preset constraint condition in the initial path;
re-performing path planning for the sub-path that does not conform to the preset constraint condition to obtain a re-planned sub-path, determining whether the re-planned sub-path conforms to the preset constraint condition; if yes, performing the step of splicing the sub-path that conforms to the preset constraint condition in the initial path and the re-planned sub-path; otherwise, re-performing path planning for the sub-path that does not conform to the preset constraint condition until all the re-planned sub-paths conform to the preset constraint condition or a quantity of times of re-planning reaches a preset quantity threshold; and
splicing a sub-path that conforms to the preset constraint condition in the initial path and the re-planned sub-path to obtain a task path before controlling the autonomous mobile machine to move, and controlling the autonomous mobile machine to move and execute a corresponding handling task according to the task path, wherein before determining the sub-path that does not conform to the preset constraint condition in the initial path, the method further comprises:
determining at least one segment point in the initial path, and segmenting the initial path at a position of the at least one segment point to obtain a plurality of sub-paths;
wherein the segment point comprises at least one of a narrow point, an entrance position point of a narrow segment, an exit position point of the narrow segment and position points at a preset length interval.
